(19) United States
(12) Patent Application Publication
(10) Pub. No.: US 2026/0121816 A1
(43) Pub. Date: Apr. 30, 2026

(54) DYNAMIC SUBBAND SWITCHING OPERATIONS IN A WIRELESS NETWORK

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 19/370,441

(22) Filed: Oct. 27, 2025

Related U.S. Application Data
(60) Provisional application No. 63/712,520, filed on Oct. 27, 2024.

(51) Int. Cl. H04L 5/00; H04L 47/2425

(52) U.S. Cl. CPC H04L 5/0094; H04L 47/2433

(57) ABSTRACT

Methods and apparatus are described for Dynamic Subband Operation (DSO) between devices of a wireless network. A first device transmits a request frame soliciting approval from a second device to enable DSO functionality in a link of the first device. The request frame indicates a DSO subband, a padding delay value indicating a time required by the first device to switch from a primary subband to the DSO subband, and a transition delay value indicating a time required by the first device to switch from the DSO subband to the primary subband. In response to the request frame, the first device receives an approval from the second device to enable DSO functionality. In response to the approval from the second device, the first device enables DSO functionality in the link of the first device. In an embodiment, the first device further receives a control frame including a request that the first device switch to the DSO subband at the beginning of a transmission opportunity (TXOP).

### CROSS REFERENCE TO RELATED APPLICATIONS

The present U.S. Utility Patent Application claims priority pursuant to 35 U.S.C. § 119(e) to U.S. Provisional Application No. 63/712,520, entitled “DSO OPEN TOPICS”, filed Oct. 27, 2024, the contents of which is hereby incorporated herein by reference in its entirety and made part of the present U.S. Utility Patent Application for all purposes.

### TECHNICAL FIELD

This disclosure relates generally to wireless communications, and more specifically to dynamic subband switch operations in a wireless network.

### BACKGROUND

Wireless local area networks (WLANs) have evolved rapidly over the past couple of decades, including WLANs that conform to the Institute of Electrical and Electronics Engineers (IEEE) 802.11 family of standards. A typical 802.11-based WLAN is formed by one or more access points (APs) that provide a shared wireless communication medium for servicing a number of client devices or stations (STAs). In particular, an AP manages a Basic Service Set (BSS) that is identified by a Basic Service Set Identifier (BSSID) and advertised by the AP. The AP periodically broadcasts beacon frames to enable STAs within wireless range of the AP to establish and maintain communication links with the AP. Control information is used in a WLAN to manage and optimize such wireless communications.

Efforts are currently underway to develop 802.11 features that allow an AP (as a transmission opportunity (TXOP) holder) to request that a STA having an operating channel that is narrower than the BSS operating channel bandwidth (BW) to switch to a secondary channel to perform frame exchanges with the AP.

### BRIEF DESCRIPTION OF THE DRAWINGS

FIG. 1 illustrates an example of a multi-link communications system in accordance with embodiments of the present disclosure;

FIG. 2 illustrates a context for dynamic channel switching operations in accordance with embodiments of the present disclosure;

FIG. 3 illustrates a frame exchange sequence in a link between an AP MLD and a non-AP MLD for enabling and disabling DSO operations in accordance with an embodiment of the present disclosure;

FIG. 4 is a flow chart illustrating an example method for changing the operating bandwidth of a DSO-enabled station in accordance with an embodiment of the present disclosure;

FIG. 5 is a flow chart illustrating an example method enabling an enhanced Multi-Link Single Radio (eMLSR) link in a DSO-enabled station in accordance with an embodiment of the present disclosure;

FIG. 6 is a flow chart illustrating an example method for medium synchronization when switching to a DSO subband in accordance with an embodiment of the present disclosure; and

FIG. 7 illustrates an example of an AP/STA according to an embodiment of the present disclosure.

### DETAILED DESCRIPTION

Among other features, the various implementations described in the following description relate generally to dynamic channel switching operations/Dynamic Subband Operation (DSO). More specifically, novel procedures are disclosed for supporting DSO negotiation, medium synchronization when switching between a DSO subband and a primary subband, coexistence of eMLSR and DSO modes of operation in a wireless device, and other features associated with the IEEE 802.11bn amendment to the IEEE 802.11 standard (also referred to as Ultra High Reliability or “UHR” or “Wi-Fi 8”) and future (or earlier) generations of the IEEE 802.11 standard.

In an example, a first device transmits a request frame soliciting approval from a second device to enable Dynamic Subband Operation (DSO) functionality in a link of the first device. The request frame indicates a requested DSO subband, a padding delay value indicating a time required by the first device to switch from a primary subband to the DSO subband, and a transition delay value indicating a time required by the first device to switch from the DSO subband to the primary subband. In response to the request frame, the first device receives an approval from the second device to enable DSO functionality in the link. In response to the approval from the second device, the first device enables DSO functionality in the link of the first device. In an embodiment, the first device subsequently receives a control frame including a request that the first device switch to the DSO subband at the beginning of a transmission opportunity (TXOP).

As used herein, the term “non-legacy” may refer to physical layer protocol data unit (PPDU) formats and communication protocols conforming with the IEEE 802.11bn amendment to the IEEE 802.11 standard (“802.11bn”) as well as future generations/amendments. In contrast, the term “legacy” may be used herein to refer to PPDU formats and communication protocols conforming to the IEEE 802.11be (also referred to as Extremely High Throughput or “EHT” or “Wi-Fi 7”) or IEEE 802.1 lax (also referred to as High Efficiency or “HE” or “Wi-Fi 6/6E”) amendments to the IEEE 802.11 standard, or earlier generations of the IEEE 802.11 standard, but not conforming to all mandatory features of 802.11bn or future generations of the IEEE 802.11 standard.

Particular implementations of the subject matter described in the present disclosure can be implemented to realize one or more of the following potential advantages. By improving and expanding support for dynamic channel switching operations, the described methodologies improve overall channel utilization, reduce contention and backoff delays, improve latency for real-time traffic, facilitate device coexistence, and simplifies multi-AP coordination. In addition, the techniques described herein help enable gains in overall network throughput (particularly in high-density environments) that will be achievable in accordance with the IEEE 802.11bn amendment to the IEEE 802.11 standard.

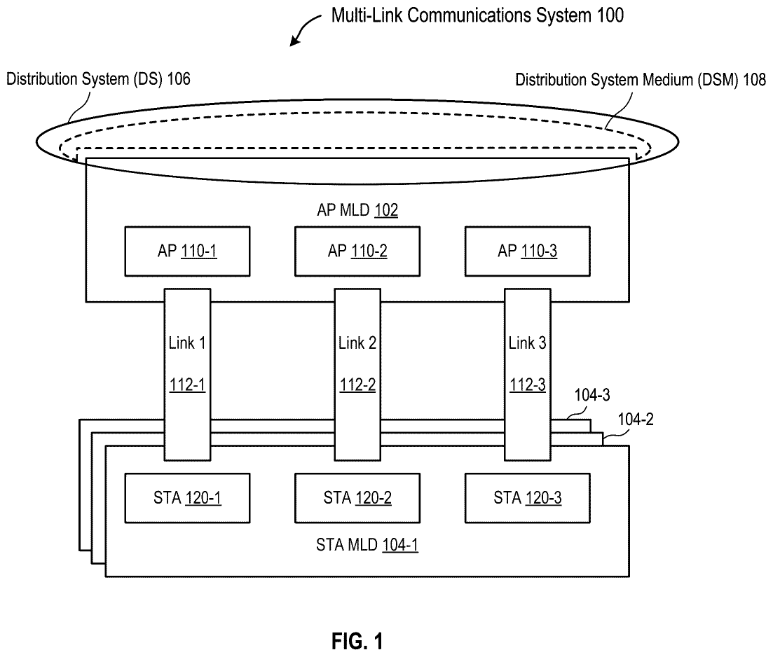

FIG. 1 illustrates an example of a multi-link (ML) communications system 100 in accordance with embodiments of the present disclosure. The illustrated multi-link communications system 100 includes at least one AP multi-link device (MLD) 102 and one or more non-AP multi-link devices (which may also be referred to herein as a “non-AP MLD” or “STA MLD”), which are, for example, implemented as station (STA) MLDs 104-1, 104-2, and 104-3. The multi-link communications system 100 can be used in various applications, such as industrial applications, medical applications, computer applications, and/or consumer or appliance applications. In the illustrated example, the multi-link communications system is a wireless communications system compatible with an IEEE 802.11 standard. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 shown in FIG. 1 includes the AP MLD 102 and the STA MLDs 104-1, 104-2, and 104-3, in other embodiments, the multi-link communications system includes other multi-link devices, such as, multiple AP MLDs and multiple STA MLDs, a single AP MLD and a single STA MLD. In another example, the multi-link communications system includes more than three STA MLDs and/or less than three STA MLDs. Although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, and 110-3. In some embodiments, the AP MLD 102 is an AP multi-link logical device or an AP multi-link logical entity (MLLE). In some embodiments, a common part of the AP MLD 102 implements upper layer Media Access Control (MAC) functionalities that are common to multiple links (e.g., association establishment, reordering of frames, etc.) and a link specific part of the AP MLD 102, i.e., the APs 110-1, 110-2, and 110-3, implement the upper layer functionalities specific to a link and lower layer MAC functionalities (e.g., beaconing, backoff, frame transmission, frame reception, etc.). The APs 110-1, 110-2, and 110-3 may be implemented in hardware (e.g., circuits), software, firmware, or a combination thereof. At least one of the APs 110-1, 110-2, or 110-3 may be fully or partially implemented as an integrated circuit (IC) device. In some embodiments, the AP MLD and its affiliated APs 110-1, 110-2, and 110-3 are compatible with at least one WLAN communications standard (e.g., at least one IEEE 802.11 standard). For example, the APs 110-1, 110-2, and 110-3 may be wireless APs compatible with at least one non-legacy IEEE 802.11 standard.

In some embodiments, an AP MLD (e.g., the AP MLD 102) is connected to a local network (e.g., a local area network (LAN)) and/or to a backbone network (e.g., the Internet) through a wired connection and wirelessly connects to wireless STA MLDs, for example, through one or more WLAN communications standards, such as an IEEE 802.11 standard. In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. The at least one controller may be implemented within a processor, such as a microcontroller, a host processor, a host, a digital signal processor (DSP), processing module, or a central processing unit (CPU), which can be integrated in a corresponding transceiver.

Each of the APs 110-1, 110-2, and 110-3 of the AP MLD 102 may operate in the same different frequency bands. For example, at least one of the APs 110-1, 110-2, or 110-3 of the AP MLD 102 operates in an Extremely High Frequency (EHF) band or the “millimeter wave (mmWave)” frequency band. In some embodiments, a mmWave link may operate in a 45 GHz or 60 GHz frequency band. In a specific example, the AP 110-1 may operate in a 6 GHz band (e.g., with a 320 MHz Basic Service Set (BSS) operating channel or other suitable BSS operating channel), the AP 110-2 may operate in a 2.4/5 GHz band (e.g., with a 20/40/80/160 MHz BSS operating channel or other suitable BSS operating channel), and the AP 110-3 may operate in a 60 GHz band (e.g., with a 160 MHz BSS operating channel or other suitable BSS operating channel).

In the illustrated embodiment, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 (non-AP MLD) includes radios, which are implemented as multiple non-AP stations (STAs) 120-1, 120-2, and 120-3. The STAs 120-1, 120-2, and 120-3 may be implemented in hardware (e.g., circuits), software, firmware, or a combination thereof. At least one of the STAs 120-1, 120-2, and 120-3 may be fully or partially implemented as an IC device. In some embodiments, the non-AP STAs 120-1, 120-2, and 120-3 are part of the STA MLD 104-1, such that the STA MLD may be a communications device that wirelessly connects to an AP MLD, such as, the AP MLD 102. For example, the STA MLD 104-1 (e.g., at least one of the non-AP STAs 120-1, 120-2 or 120-3) may be implemented in a laptop, a desktop computer, a mobile phone, or other communications device that supports at least one WLAN communications standard. In some embodiments, the STA MLD and its affiliated STAs 120-1, 120-2, and 120-3 are compatible with at least one IEEE 802.11 standard. In an example, each of the non-AP STAs 120-1, 120-2, and 120-3 includes at least one antenna, at least one transceiver operably connected to the at least one antenna, and at least one controller connected to the corresponding transceiver. The at least one transceiver may include a PHY device. The at least one controller can be configured to control the at least one transceiver to process received packets through the at least one antenna. In some embodiments, the at least one controller is implemented by a processor, such as a microcontroller, a host processor, a host, a DSP, processing module, or a CPU, which can be integrated in a corresponding transceiver. In an example, the STA MLD has one MAC data service interface. In another example, a single address is associated with the MAC data service interface and is used to communicate on the DSM 108. In some embodiments, the STA MLD 104-1 implements a common MAC data service interface and the non-AP STAs 120-1, 120-2, and 120-3 implement a lower layer MAC data service interface.

In an example, the AP MLD 102 and/or the STA MLDs 104-1, 104-2, and 104-3 identify which communications links support the multi-link operation during a multi-link operation setup phase and/or exchanges information regarding multi-link capabilities during the multi-link operation setup phase. In addition, each of the STAs 120-1, 120-2, and 120-3 of the STA MLD may operate in the same frequency band or different frequency bands. For example, at least one of the STAs 120-1, 120-2, or 120-3 of the STA MLD 104-1 operates in the mmWave frequency band (e.g., a 45 GHz or 60 GHz frequency band). In an example, the STA 120-1 may operate in a 6 GHz band (e.g., with a 320 MHz BSS operating channel or other suitable BSS operating channel), the STA 120-2 may operate in a 2.4/5 GHz band (e.g., with a 20/40/80/160 MHz BSS operating channel or other suitable BSS operating channel), and the STA 120-3 may operate in a 60 GHz band (e.g., with a 640 MHz BSS operating channel or other suitable BSS operating channel). Although the STA MLD 104-1 is shown in FIG. 1 as including three non-AP STAs, other embodiments of the STA MLD 104-1 may include fewer than three non-AP STAs or more than three non-AP STAs.

Each of the MLDs 104-2, 104-3 may be the same as or similar to the STA MLD 104-1. For example, the MLD 104-2 and 104-3 include one or multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller can be configured to control the at least one transceiver to process received packets through the at least one antenna. In some embodiments, the at least one controller is implemented by a processor, such as a microcontroller, a host processor, a host, a DSP, a processing module, or a CPU, which can be integrated in a corresponding transceiver.

In the illustrated network, the STA MLD 104-1 communicates with the AP MLD 102 through multiple communications links 112-1, 112-2, 112-3. For example, each of the STAs 120-1, 120-2, 120-3 communicates with an AP 110-1, 110-2, or 110-3 through a corresponding wireless communications link 112-1, 112-2, or 112-3. Although the AP MLD 102 communicates (e.g., wirelessly communicates) with the STA MLD 104-1 through multiple links 112-1, 112-2, 112-3, in other embodiments, the AP MLD 102 may communicate (e.g., wirelessly communicate) with the STA MLD through more than three communications links or less three than communications links. In some embodiments, the wireless communications links in the multi-link communications system include one or more 2.4 GHz, 5 GHz, 6 GHz, 45 GHz and/or 60 GHz links.

As described above, a multi-link AP MLD has one or multiple links where each link utilizes one AP affiliated with the AP MPD. This may be accomplished by having different radios for different affiliated APs.

A multi-link STA MLD (or non-AP MLD) has one or multiple links where each link has one STA affiliated with the STA MLD. One way to implement the multi-link STA MLD is using two or more radios, where each radio is associated with a specific link. For example, an multi-link multi-radio (MLMR) non-AP MLD may be used. The MLMR non-AP MLD uses multiple full functional radios to monitor the medium in multiple links. Another way to implement the multi-link STA MLD is using a single radio in two different bands. Each band may be associated with a specific link. In this case, only one link is available at a time. In yet another implementation, an enhanced single-radio (ESR) STA MLD may be used that operates in an enhanced Multi-Link Single Radio (eMLSR) multi-link mode. In eMLSR, a device with a “single” radio interface can manage multiple links more efficiently than basic time-division multiplexing. For example, instead of switching the radio back and forth, an eMLSR STA MLD can use multiple receive chains to “listen” on several links simultaneously while also transmitting or receiving payload data on only one link at any given point in time.

In an example, an ESR STA MLD uses two radios in different bands to implement the MLD. One radio may be a lower cost radio or receive chain with lesser capabilities and the other radio may be a fully functional radio supporting the latest protocols. The ESR STA MLD may dynamically switch its working link while it can only transmit or receive through one link at any time. In this example, each radio may have its own backoff time, and when the backoff counter for one of the radios becomes zero that radio and link may be used for transmission. For example, if an AP wants to use a fully functional radio, it may send a control frame that is long enough for the ESR STA MLD to switch from the lesser capable radio to the fully functional radio for data exchange to the AP.

In general, “link listening” in eMLSR refers to a process in which a STA MLD actively monitors non-active links for medium activity and essential control information without sending or receiving data frames on those links. In an example, link listening for non-active link(s) entails performing Clear Channel Assessment (CCA) (e.g., energy detection and signal decoding) to update associated network allocation vector(s) and determine if a channel is free, preamble and control frame detection to detect the start of management or control frames (e.g., beacons and Trigger frames), and partial frame reception of control frames to identify scheduling or link state changes before handing off an active link for data exchange. Such simultaneous listening helps ensure that a STA MLD stays synchronized with an AP's multi-link coordination, and also reduces latency when switching the single radio to another link for actual data transmission.

As used herein, the “operating bandwidth” of a STA refers to the contiguous frequency bandwidth that its PHY is configured to use for transmission and reception (e.g., 20 MHz, 40 MHz, 80 MHz, 160 MHz, or 320 MHz). For example, the operating bandwidth of a STA includes the BSS's primary 20 MHz channel plus any secondary (and contiguous) 20 MHz channels that are covered by the STA's bandwidth. The operating bandwidth of a STA always includes a designated primary 20 MHz within the wider operating bandwidth (e.g., for use by control and some legacy operations). As used herein, the terms “switch” and “switching” generally refer to changing the operating channel of a wireless device (e.g., for purposes of a future frame exchange).

For purposes of the present disclosure, the term “DSO” generally refers to both Dynamic Subband Operation, and includes concepts such as switching from one channel/subband that is the same as the STA's operating bandwidth (primary subband) to another channel/subband (e.g., a STA's DSO subband negotiated between the STA and an AP). Dynamic subband switch operations solicit a STA's switch from its primary subband to its negotiated secondary subband. Dynamic Subband Operation enables a single channel (e.g., up to 320 MHz) to be flexibly partitioned into multiple, independently scheduled subbands. For example, Dynamic Subband Operation is a mode that allows an AP assign a specific subband inside its operating channel to an associated non-AP STA as the STA's DSO subband (outside the STA's current operating bandwidth), using control signaling (for example an ICF) so the STA can switch to its DSO subband and exchange frames on its secondary subband. In an example, a STA switching to its negotiated DSO subband from the primary subband for a TXOP switches back to the primary channel (primary subband) at the end of the TXOP. The negotiated DSO subband of a STA outside the STA's operating bandwidth may be referred to herein as a “DSO subband”. The STA's primary subband covers the BSS primary channel and has the same width as the STA's operating bandwidth. The STA's DSO subband does not cover the BSS primary channel and has the same width as the STA's operating bandwidth.

A STA “parked” in a channel means the STA remains tuned to that particular channel while it is otherwise idle or not actively participating in transmissions. Parking is relatively low-activity state in which the STA stays tuned to the channel so it can receive beacons, control frames, or buffered data from an AP.

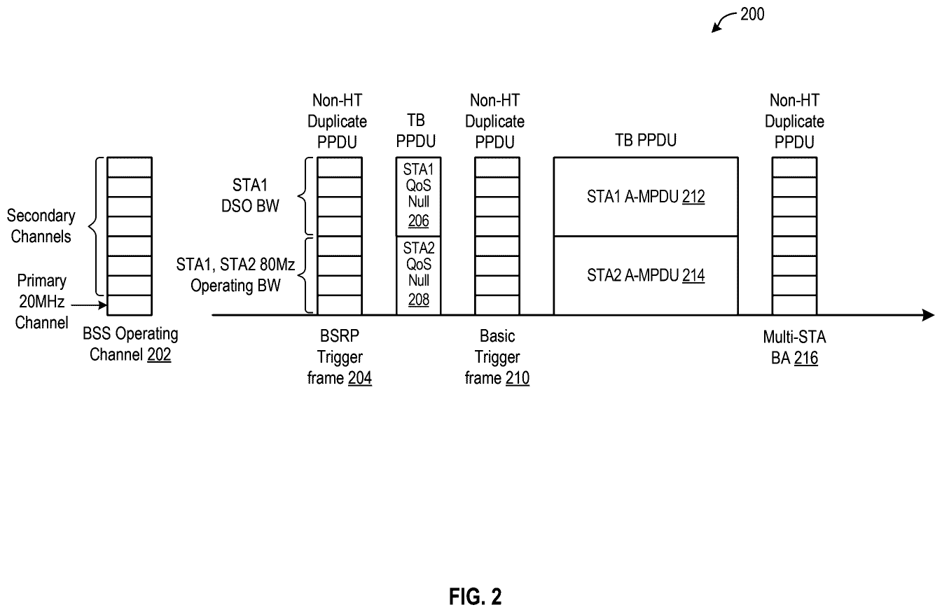

FIG. 2 illustrates a context 200 for dynamic channel switching operations in accordance with embodiments of the present disclosure. In the illustrated example, the BSS includes an AP with two associated STAs (STA1 and STA2) and has an 160 MHz BSS operating channel (or bandwidth) 202. The BSS operating channel 202 includes one primary channel and seven secondary 20 MHz channels (2nd to 8th 20 MHz channels). In this example, the BSS operating channel 202 is divided into two subbands with a primary 80 MHz channel being the primary subband and the secondary 80 MHz channel being the secondary subband. The AP announces its secondary 80 MHz channel as the DSO subband. STA1 and the AP negotiate the DSO subband for STA1. The stations STA1 and STA2 each have an 80 MHz operating bandwidth, and park in the primary subband, i.e., the primary 80 MHz operating channel of the BSS operating channel 202. In this example, the AP transmits a Buffer Status Report Poll (BSRP) Trigger frame 204 to initiate communication with STA1 and STA2 in a TXOP. For example, the BSRP Trigger frame 204 (initial control frame (ICF)) instructs STA1 to switch to STA1's DSO subband within the BSS operating channel 202. In response, the STA1 switches to its DSO subband (e.g., prior to the end of the BSRP Trigger frame) and sends the responding frame in the in the DSO subband as indicated by the AP through BSRP Trigger frame 204. In the illustrated example, in response to the BSRP Trigger frame 204, STA1 transmits a QoS Null message 206 (initial control response frame (ICR)) and STA2 transmits a QoS Null message 208 in different 80 MHz operating bandwidths (e.g., in a Trigger-Based Physical Protocol Data Unit (TB PPDU)).

In the illustrated example, the AP may the transmit a basic Trigger frame 210 to solicit an A-MPDU from STA1 and STA2 in different Resource Units (RUs). In response, STA1 and STA2 transmit a TB PPDU that includes STA1 Aggregated MAC Protocol Data Unit (A-MPDU) 212 and STA2 A-MPDU 214. In this example, the AP then transmits a Multi-STA Block Acknowledgement (Muli-STA BA) frame 216 (in a non-HT duplicate PPDU) to indicate the end of the TXOP. At this point, STA1 switches back to the primary subband (primary 80 MHz channel of the BSS operating channel 202) to monitor the medium.

In an example, during a TXOP a STA dynamically switches to its DSO subband if theResou(s) being allocated to the STA in an ICF are covered by the STA's DSO subband. The DSO subband of a STA is determined by the STA's negotiation for enabling the STA's DSO operation. In an example, in a 160 MHz BSS operating bandwidth, a 20 MHz STA may negotiate a secondary 20 MHz channel as its DSO subband. In another example, in a 160 MHz BSS operating bandwidth, an 80 MHz STA may a negotiate secondary 80 MHz channel as its DSO subband. If the 80 MHz STA acquires a 52-tone RU in the 5th secondary channel in a BSRP Trigger frame (as ICF) in a TXOP, the STA switches to its DSO subband in the TXOP.

While the channel configurations described above are used to provide a context for switching a STA to its DSO subband, the principles and operations described herein may be applied to other channel configurations. In addition, while the principles and operations are described for a primary subband and a DSO subband, the AP may have third, fourth, fifth, and other subbands. The particular structure and format of a dynamic channel switch may be adapted to suit different channel configurations.

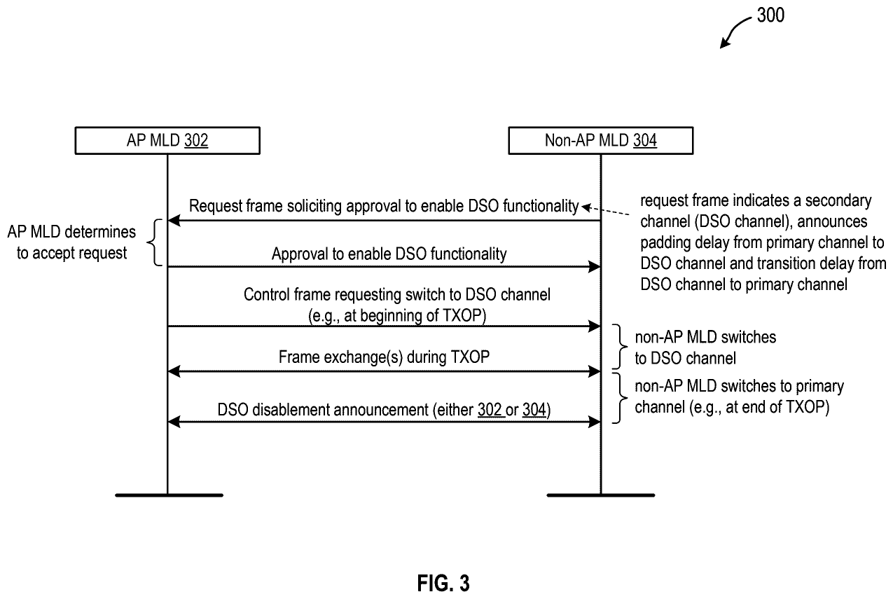

FIG. 3 illustrates a frame exchange sequence 300 in a link between an AP MLD 302 (e.g., an AP of the AP MLD) and a non-AP MLD 304 (e.g., a STA MLD) for enabling and disabling DSO operations in accordance with an embodiment of the present disclosure. In some embodiments, if an AP MLD announces its enablement of DSO operation in the link, a non-AP MLD associated with the AP MLD may enable its DSO operation in the link, i.e., accept DSO enablement requests in the link. If an AP MLD doesn't announce its enablement of DSO operation in link, a non-AP MLD associated with the AP MLD is not allowed to enable its DSO operation in the link. Prior to the illustrated frame exchange sequence, the AP MLD 302 may first announce to the non-AP MLD 304 that it will accept DSO enablement requests from the non-AP MLD 304 in a link. In the illustrated example, the non-AP MLD 304 determines that it would like to enable DSO operations in the link and sends a request frame soliciting approval from the AP MLD 302 to enable DSO functionality in the link. In an example, the DSO enablement request frame includes an indication of a DSO subband of the link (e.g., with the same bandwidth (BW) as its operating BW) that the non-AP MLD 304 intends to switch to in response to a soliciting ICF from the AP MLD 302. The request frame from the non-AP MLD 304 may further include the padding delay value for switching from the primary subband to the DSO subband and a transition delay value for switching from the DSO channel back to the primary channel. In an example, the padding delay value and/or transition delay value may indicate a range of values from Ous to 252 us using a granularity of 4 us. In another example, the transmission time of the padding of an initiating frame requesting that a STA perform a dynamic channel switch is not less than the associated padding delay value of the STA.

In response to decoding the DSO enablement request frame, the AP MLD 302 determines whether to accept or reject the request. In some embodiments, the AP MLD 302 always accepts the DSO enablement request. In the illustrated example, the AP MLD 302 determines to accept the DSO enablement request and transmits an approval to enable DSO functionality in the non-AP MLD 304. In this example, the AP of the AP MLD 302 in the link further generates and transmits a control frame, such as an initial control frame (ICF) in the link, to solicit the STA in the non-AP MLD 304 to switch to the DSO subband (e.g., at the beginning of a TXOP) in the link. In an example, the ICF is a (modified) BSRP Trigger frame followed by a responsive QoS Null frame from the non-AP MLD 304. In another example the ICF is a (modified) MU-RTS frame followed by a responsive CTS frame from the non-AP MLD 304.

A BSRP Trigger frame used as the soliciting ICF in a link may include a variable length padding field to extend the frame length for the following purposes: (1) to give the recipient STA of the non-AP MLD 304 in the link enough time to decode the BSRP Trigger frame and prepare a response (e.g., an Initial Control Response (ICR)) for transmission an SIFS after the frame is received and (2) to provide the STA of the non-AP MLD 304 in the link sufficient time to perform a channel switch (e.g., in accordance with the STA's padding delay value for DSO), an operating mode switch from a low capability mode to a high capability mode, etc. If the BSRP Trigger frame further solicits a Multi-STA Block Ack and QoS Null from the STA, the allocated resources are also sufficient to include the Multi-STA Block Ack and QoS Null in the response.

In the illustrated example, the STA of the non-AP MLD 304 in the link switches to the DSO subband and performs a frame exchange(s) with the AP of the AP MLD 302 (e.g., during the TXOP) over the DSO subband in the link. At the end of the TXOP (or prior to the end of the TXOP), the STA of the non-AP MLD 304 in the link switches back to its primary channel if the STA detects the same condition that triggers an eMLSR STA to switch from frame exchange operation to listening operation. Continuing with this example, either of the AP MLD 302 or non-AP MLD 304 may transmit a DSO disablement announcement (e.g., in response to changing network conditions or following completion of management frame exchanges. In some embodiments, only the non-AP MLD can disable the non-AP MLD's DSO operation in a link if the AP MLD still enables DSO operation in the link. In some embodiments, if the AP MLD announces disablement of DSO operation in the link, all of the DSO operations enabled by the non-AP MLD in the link are disabled.

Different options for medium synchronization during a DSO mode of operation are described in the following paragraphs. In a first option, if an AP schedules a STA to switch to a DSO channel not covered by the STA's operating bandwidth during a TXOP, the AP guarantees (through one or more frame exchanges) that the STA is allocated sufficient time to perform medium clear channel assessment (CCA) on the primary channel at the end of the TXOP. In an example, the AP guarantees that the end time of a STA's last frame exchange on a switched DSO subband precedes the end time of the TXOP by at least the transition delay of the STA required to switch back to a primary channel. In this manner, the STA will not lose medium synchronization after switching back to the primary channel.

In a second option, a STA operating in a DSO channel loses medium synchronization for a switch back to the primary channel in a TXOP of the following conditions are true: (1) the AP schedules the STA to the STA's DSO subband; (2) the STA's transition delay from the DSO subband to the primary subband is more than a threshold (e.g., aMediumSyncThreshold=72 us) and the STA is not able to determine the end time of the TXOP; or (3) the STA can determine the end time of the TXOP is 72 us earlier than the time required by the STA to finish a transition from the DSO channel to the primary channel. Although this second option is more complicated than the first option, it is able to address most error conditions.

In a third option, a STA operating in a DSO channel loses medium synchronization for a switch back to the primary channel in a TXOP if the following conditions are true: (1) the AP schedules the STA to the STA's DSO subband; (2) the STA's transition delay from the DSO subband to the primary subband is more than threshold (e.g., aMediumSyncThreshold=72 us).

Under the first option described above, potential issues may arise due to error conditions such as transmission failures. In general, upon a transmission failure within an EDCA TXOP, an AP (or STA) can recover by using Priority Inter Frame Space (PIFS) recovery or backoff recovery. For example, PIFS recovery allows an AP to wait for a relatively short PIFS interval and then immediately retry a failed frame within the same TXOP without invoking the full backoff process. Backoff recovery invokes the standard backoff procedure (e.g., the contention window may be doubled and a random backoff counter selected). Under a backoff procedure, the AP retries the frame when its backoff counter reaches zero.

In an example involving an AP's recovery following a transmission failure, a frame exchange includes an AP's downlink (DL) BSRP Trigger frame, an uplink (UL) QoS Null (e.g., corresponding with a first STA's DSO switch) in a TB PPDU, a DL MU PPDU (to the first STA and other STAs), a Block Acknowledgment (BA) frame in a TB PPDU, the AP's PIFS recovery or backoff recovery, etc. When the first STA switches back to its primary band following the associated AP's recovery, the first STA may not be able to successfully receive a post-recovery PPDU from the AP. If the first STA cannot detect the PPDU from the associated AP (or other source), the STA may not be able to determine when to perform a medium CCA on the primary channel.

Various approaches may be used to address this situation in accordance with the present disclosure. In an example wherein the DSO channel of a STA is not included in its operating bandwidth, an associated AP transmits a frame to the STA via a primary channel. The frame includes a duration field set to a value that protects a subsequent exchange of frames during the TXOP. In response to receiving the frame, the STA sets an intra-Basic Service Set (BSS) network allocation vector (NAV) timer value based on the Duration field. When the STA subsequently switches from the primary channel to the DSO channel, the STA maintains the intra-BSS NAV timer in order to maintain medium synchronization.

In further examples, the AP utilizes whole TXOP protection, or at least the following rule of Section 9.2.5.2 of the 802.1 lax amendment to the IEEE 802.11 standard is disallowed: “In an MU-BAR Trigger frame, BSRP Trigger frame, GCR MU-BAR Trigger frame, BQRP Trigger frame, and NFRP Trigger frame, the Duration/ID field is set to the time required to transmit the solicited HE TB PPDU plus one SIFS.” In an example, the AP sets the Duration field of a frame in a current frame exchange to at least protect the following frame exchange of the current frame exchange: SIFS+responding PPDU length in the current frame exchange+SIFS+(length of the PPDU carrying the AP's acknowledgement+SIFS if Duration is carried in a Trigger frame)+soliciting PPDU length of the next frame exchange+SIFS+responding PPDU length of the of the next frame exchange+SIFS+(length of the PPDU carrying the AP's acknowledgement if Duration is carried in a Trigger frame).

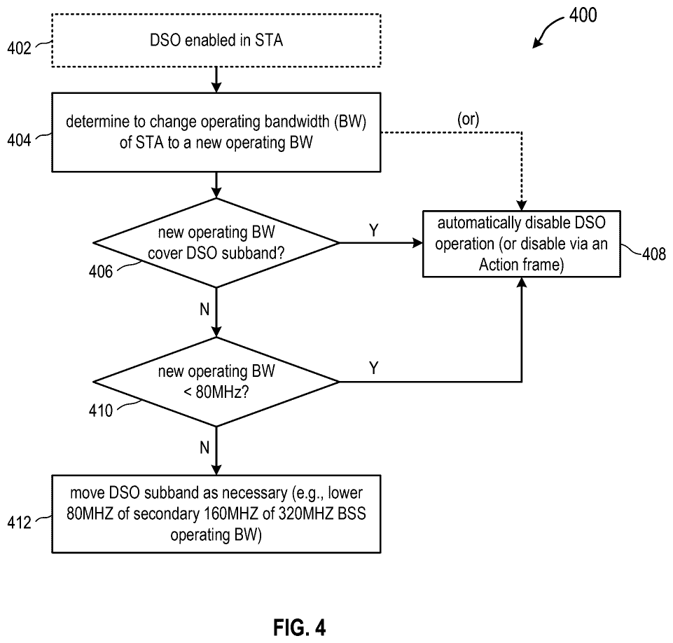

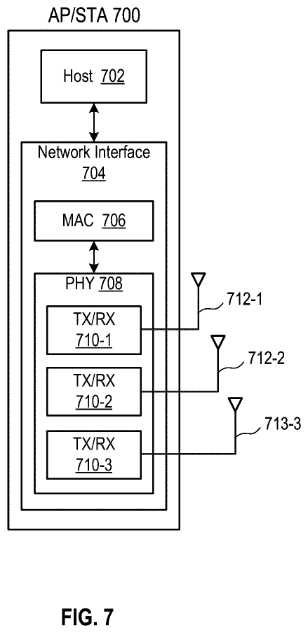

FIG. 4 is a flow chart illustrating an example method 400 for changing the operating bandwidth of a DSO-enabled station in accordance with an embodiment of the present disclosure. The method 400 can be performed by an access point (AP) and/or station (STA), such as an AP/STA affiliated with the AP MLD 102 or the STA MLD 104 described with reference to FIG. 1, or the wireless AP/STA 700 described with reference to FIG. 7. The method 400 may be utilized, for example, to accommodate DSO/dynamic channel switching operations associated with the IEEE 802.11bn amendment to the IEEE 802.11 standard when changing the operating bandwidth of a STA.

In certain circumstances, a STA that has enabled a DSO mode of operation may determine to change its operating bandwidth. For example, the STA may widen or narrow its operating bandwidth in response to detecting interference (or as instructed by an affiliated AP). As a result of the (pending) change in operating bandwidth, and depending on the relative location and/or width of the updated operating bandwidth and the DSO subband, the DSO mode of operation may be disabled in various manners, examples of which are described below.

The illustrated method begins at step 402, where a non-AP MLD with an affiliated STA enables the DSO operation in the STA. Next, at step 404, the non-AP MLD determines to change the operating bandwidth (BW) of the STA to a new operating bandwidth. In one example, the non-AP MLD/STA can be configured to automatically disable the DSO mode of operation (at step 408) when determining to change the operating bandwidth of the STA.

The illustrated method continues at step 406 where the non-AP MLD/STA determines whether the new operating bandwidth covers the enabled DSO subband. If so, the method continues at step 408 where the non-AP MLD automatically disables the DSO mode of operation. In a further example, disabling the DSO mode of operation may include receiving an Action frame from an associated AP MLD.

In some embodiments, a 160 MHz BSS has a primary subband that is a primary 80 MHz channel and a DSO subband that is a secondary 80 MHz channel. In other embodiments, a 320 MHz BSS has a primary subband that is a primary 80 MHz channel and three 80 MHz DSO subbands that are secondary 80 MHz channels, two 80 MHz channels in a secondary 160 MHz channel, or one 160 MHz DSO subband that is a secondary 160 MHz channel. If the new operating bandwidth does not cover the enabled DSO channel as determined at step 406, the method continues at step 410 (which can precede step 406) where the non-AP MLD determines whether the new operating bandwidth is less than 80 MHZ (e.g., when the enabled DSO channel is an 80 MHz channel). If so, the non-AP MLD automatically disables the DSO mode of operation (or the DSO mode of operation is disabled via an Action frame) at step 408.

If the new operating bandwidth is at least 80 MHZ as determined at step 410, the method continues at step 412 where the non-AP MLD/STA may move the DSO subband as necessary to accommodate the new operating bandwidth. In an example, a 160 MHz STA having an enabled DSO mode of operation in a 160 MHz subband determines to change its operating bandwidth from 160 MHz to 80 MHz in a 320 MHz BSS operating bandwidth. In this example, the STA's DSO operation is relocated/established in the lower 80 MHz of the secondary 160 MHz unless the STA receives an Action frame that updates its DSO subband or disables the DSO mode of operation. In a variant of this example, the higher 80 MHz of the secondary 160 MHz is used for the STA's DSO operation.

In another example, a STA that has enabled a DSO mode of operation changes its operating bandwidth to the entire Basic Service Set (BSS) operating bandwidth. In this example, the STA can be configured to automatically disable the DSO mode of operation (or the DSO mode of operation is disabled via an Action frame).

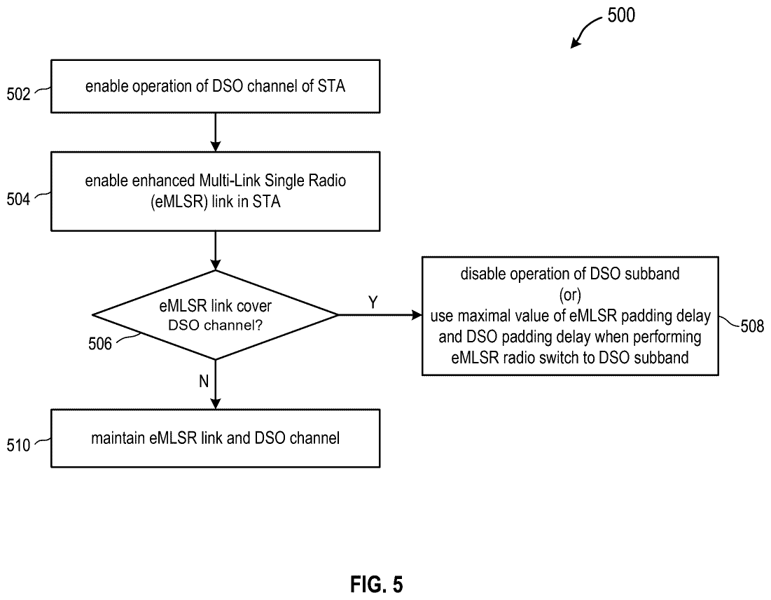

FIG. 5 is a flow chart illustrating an example method 500 enabling an enhanced Multi-Link Single Radio (eMLSR) link in a DSO-enabled station in accordance with an embodiment of the present disclosure. The method 500 can be performed by an access point (AP) and/or station (STA), such as an AP/STA affiliated with the AP MLD 102 or the STA MLD 104 described with reference to FIG. 1, or the wireless AP/STA 700 described with reference to FIG. 7. As described below, various rules can be defined for a non-AP MLD that is configurable to enable both eMLSR and DSO modes of operation. In an example, the non-AP MLD is not allowed to include a DSO link as an eMLSR link when enabling the eMLSR mode. In another example, both eMLSR and DSO modes can be enabled for a link.

The illustrated method begins at step 502, where a non-AP MLD with one affiliated STA enables operation of a DSO channel in the STA. The method continues at step 504, where the non-AP MLD enables an eMLSR link in the STA. In the illustrated method, when the eMLSR link covers the DSO subband as determined at step 506, the non-AP MLD disables operation of the DSO subband at step 508. Alternatively (as also shown at step 508), the non-AP MLD allows for an eMLSR radio switch to the primary subband of a link that enables DSO operation. In this alternative, when the non-AP MLD enables (or disables) eMLSR operation, the padding delay and transition delay relating to the DSO operation may change. In an example, when the non-AP MLD executes an eMLSR radio switch to the primary channel of a link that enables DSO operation, the padding delay (“eMLSR padding delay”) and transition delay (“eMLSR transition delay”) for eMLSR operations are utilized, i.e., the padding delay of each of eMLSR and DPS is satisfied. In a related example, when the non-AP MLD executes an eMLSR radio switch to the DSO channel of a link that enables DSO operation, the maximal value of the padding delay for eMLSR operation and the padding delay for DSO operation is utilized as the padding delay, and the maximal value of the transition delay for eMLSR operation and the padding delay for DSO operation is utilized as the transition delay. In the illustrated method, when the eMLSR link does not cover the DSO channel as determined at step 506, the non-AP MLD maintains (step 510) both the eMLSR link and the DSO operations.

In a further example, if a non-AP MLD enables or disables eMLSR operation, the eMLSR STA's (preexisting) DSO operation is maintained. In this example, an eMLSR mode request from the non-AP MLD carries the eMLSR STA's DSO padding delay and transition delay for DSO operation after the negotiated eMLSR enablement/disablement. Alternatively, an eMLSR STA's DSO operation may be automatically disabled when the non-AP MLD enables or disables its eMLSR mode of operation.

In yet another example (not separately illustrated), when an eMLSR STA enables DSO operation, the padding delay and transition delay of the eMLSR operation does not change. In this example, the STA announces its padding delay for the radio switch to the DSO subband and the STA's transition delay from the DSO subband to the primary subband independent of the eMLSR padding delay and eMLSR transition delay.

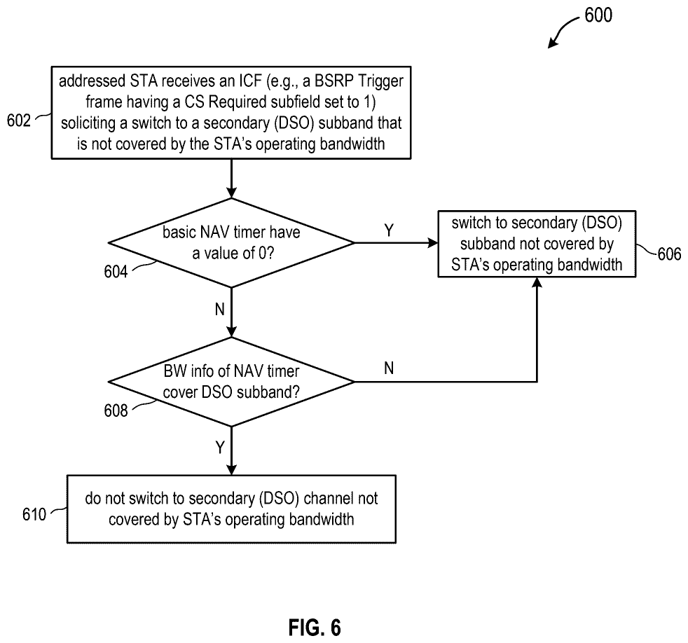

FIG. 6 is a flow chart illustrating an example method 600 for medium synchronization when switching to a DSO subband in accordance with an embodiment of the present disclosure. The method 600 can be performed by a station (STA), such as a STA affiliated with the STA MLD 104 described with reference to FIG. 1, or the wireless AP/STA 700 described with reference to FIG. 7.

In the existing IEEE 802.11 standard, if a soliciting Trigger frame includes a CS Required subfield set to 1, an addressed STA must consider the medium state and basic network allocation vector (NAV) when deciding whether to transmit. If the addressed STA has a non-zero NAV timer, the STA is not allowed to transmit the solicited TB PPDU. However, using the example of a legacy BSRP Trigger frame as an Initial Control Frame (ICF) with CS Required set to 1, it is not presently clear whether a STA that (1) has a non-zero basic NAV timer and (2) switches to its DSO subband not covered by the STA's operating bandwidth can transmit a responsive frame in a TB PPDU via the DSO subband.

The illustrated method 600 presents various options to address the foregoing situation. The method begins at step 602 where an addressed STA receives a BSRP Trigger frame configured as an ICF with a CS Required subfield set to 1. In this example, the BSRP Trigger frame solicits the STA to switch to DSO subband not covered by the STA's operating bandwidth. The method continues at step 604, where the STA determines if an associated basic NAV timer has a value of zero. If so, the STA switches (step 606) to its DSO subband.

If the basic NAV timer does not have a value zero, but includes bandwidth information, the method continues at step 608 where the STA determines whether the bandwidth information of the NAV timer indicates that the PPDU used to set the NAV timer covers the DSO subband. If not, the STA switches (at step 606) to its DSO subband. If the bandwidth information of the (non-zero) NAV timer indicates that the PPDU used to set the NAV timer covers the DSO subband as determined at step 608, the STA does not switch to the DSO channel not covered by its operating bandwidth.

In another example, a STA has a basic NAV timer and the STA switches to its DSO subband if the basic NAV timer has a value of zero. In a further example, a STA has a basic NAV timer without bandwidth information and the STA only switches to its DSO subband if the basic NAV timer has a value of zero.

FIG. 7 illustrates an example of a wireless device that is configured as an access point (AP) or station (STA) according to an embodiment of the present disclosure. The AP/STA 700 of this example is configurable to support dynamic channel switch operations/DSO functionality according to any of the various embodiments described herein (e.g., via frame exchanges with an affiliated AP/STA). The illustrated AP/STA 700 includes a host processor 702 coupled to a network interface device 704. The network interface device 704 includes a medium access control (MAC) processing unit 706 and a physical layer (PHY) processing unit 708. The PHY processing unit 708 includes a plurality of transceivers 710 coupled to a plurality of antennas 712. Although three transceivers 710 (710-1, 710-2 and 710-3) and three antennas 712 (712-1, 712-2 and 712-3) are illustrated in FIG. 1, the AP/STA 700 includes other suitable numbers (e.g., 1, 2, 4, 5, etc.) of transceivers 710 and antennas 712 in other embodiments. In an example, the MAC processing unit 706 and the PHY processing unit 708 are configured to operate in compliance with the IEEE 802.11bn amendment to the IEEE 802.11 standard. In an example, the network interface device 704 includes one or more integrated circuit (IC) devices. In this example, at least some of the functionality of the MAC processing unit 706 and at least some of the functionality of the PHY processing unit 708 can be implemented on a single IC device. As another example, at least some of the functionality of the MAC processing unit 706 is implemented on a first IC device, and at least some of the functionality of the PHY processing unit 708 is implemented on a second IC device. The AP/STA 700 may communicate (e.g., C-TDMA related communications) with a plurality of client stations and/or APs, including both legacy and non-legacy client APs and stations.

In various embodiments, the PHY processing unit 708 of the AP/STA 700 is configured to generate data units conforming to a non-legacy communication protocol and having formats described herein. The transceiver(s) 710 is/are configured to transmit the generated data units via the antenna(s) 712. Similarly, the transceiver(s) 710 is/are configured to receive data units via the antenna(s) 712. The PHY processing unit 708 of the AP/STA 700 is configured to process received data units conforming to the non-legacy communication protocol and having formats described herein and to determine that such data units conform to the non-legacy communication protocol.

In an embodiment, when operating as an AP in single-user mode, the AP/STA 700 transmits an ICF or data unit to a single client station (DL SU transmission), or receives an ICR or data unit transmitted by a single client station (UL SU transmission), without simultaneous transmission to, or by, any other client station. When operating in multi-user mode, the AP/STA 700 transmits a data unit that includes multiple data streams for multiple client stations (DL MU transmission), or receives data units simultaneously transmitted by multiple client stations (UL MU transmission). For example, in multi-user mode, a data unit transmitted by the AP includes multiple data streams simultaneously transmitted by the AP/STA 700 to respective client stations using respective spatial streams allocated for simultaneous transmission to the respective client stations and/or using respective sets of OFDM tones corresponding to respective frequency subbands allocated for simultaneous transmission to the respective client stations. In a further example, the AP/STA 700 may be configured as a multi-link device, such as the AP MLD 102 or STA MLD 104 described above with reference to FIG. 1.

While the innovative aspects of the present disclosure have been generally described in the context of the 802.11bn amendment, and future generations, of the IEEE 802.11 standard, a person having ordinary skill in the art will readily recognize that teachings and concepts herein may be applied to other wireless networks and standards including, for example, Long Term Evolution (LTE) standards and Bluetooth standards.

The innovative apparatus and methods illustrated in the figures and described herein provide novel procedures to support DSO negotiation, medium synchronization when switching between a DSO subband and a primary channel, coexistence of eMLSR and DSO modes of operation in a wireless device, and other features associated with the IEEE 802.11bn amendment to the IEEE 802.11 standard. In an illustrative, non-limiting embodiment, a method for Dynamic Subband Operation (DSO) between devices of a wireless network is provided. The method includes transmitting, by a first device, a request frame soliciting approval from a second device to enable DSO functionality in a link of the first device, wherein the second device supports DSO functionality in the link. The request frame indicates a requested DSO subband, a padding delay value indicating a time required by the first device to switch from a primary channel to the DSO channel, and a transition delay value indicating a time required by the first device to switch from the DSO subband to the primary subband. The method further includes receiving, in response to the request frame, an approval from the second device to enable DSO functionality of the first device. In response to the approval from the second device, the first device enables DSO functionality in the link.

The method of this embodiment includes optional aspects. With one optional aspect, the method further includes receiving a control frame from the second device, the control frame including a request that the first device switch to the DSO subband at the beginning of a transmission opportunity (TXOP). In this optional aspect, the first device switches from the primary subband to the DSO subband and performs, during the TXOP, a frame exchange with the second device via the DSO subband. In another optional aspect, the method includes switching, at or prior to the end of the TXOP, from the DSO subband to the primary subband. In another optional aspect, the method further includes determining, by the first device, to change an operating bandwidth of the first device to a new operating bandwidth, and disabling DSO functionality in the first device in response to determining to change the operating bandwidth. In yet another optional aspect, disabling DSO functionality in the first device does not include transmitting an Action frame to the second device. In a further optional aspect, disabling DSO functionality in the first device includes transmitting an Action frame to the second device.

In another optional aspect, the first device enables an enhanced Multi-Link Single Radio (eMLSR) mode on the DSO subband. In yet another optional aspect, the method further includes announcing, by the first device, an eMLSR padding delay and eMLSR transition delay. In a further optional aspect, the DSO subband is not included in an operating bandwidth of the first device. In this optional aspect, the method further includes setting an intra-Basic Service Set (BSS) network allocation vector (NAV) timer value of the first device based on a frame received by the first device via the primary subband and switching, by the first device, from the primary subband to the DSO subband while maintaining the intra-BSS NAV timer. In another optional aspect, the method further includes receiving a DSO disablement announcement for the link from the second device and, in response, automatically disabling DSO functionality in the first device. In a further optional aspect, the first device is a non-Access Point Multi-Link Device (non-AP MLD) and the second device is an Access Point Multi-Link Device (AP MLD).

In another illustrative, non-limiting embodiment, a method for Dynamic Subband Operation (DSO) between devices of a wireless network is provided. The method includes receiving, by a first device, a request frame soliciting approval from the first device to enable DSO functionality in a link of the second device. The request frame indicates a requested DSO subband, a padding delay value indicating a time required by the second device to switch from a primary subband to the DSO subband, and a transition delay value indicating a time required by the second device to switch from the DSO subband to the primary subband. The method further includes transmitting, in response to the request frame, an approval to the second device to enable DSO functionality in the link of the second device.

This second embodiment includes optional aspects. With one optional aspect, the method includes transmitting, by the first device, a control frame for reception by the second device, the control frame including a request that the second device switch to the DSO subband at the beginning of a transmission opportunity (TXOP). The method of this optional aspect further includes performing, during the TXOP, a frame exchange with the second device via the DSO subband. In another optional aspect, performing a frame exchange with the second device includes transmitting, by the first device, a frame including a duration field set to a value that protects a subsequent exchange of frames during the TXOP. In a further optional aspect, performing a frame exchange with the second device includes transmitting, by the first device, a frame configured to ensure that an end time of a last frame exchange with the second device precedes the end time of the TXOP by at least the transition delay value.

With another illustrative, non-limiting embodiment, a first device includes one or more wireless transceivers and one or more processors operably coupled to the one or more wireless transceivers. The one or more processors are arranged to transmit, via the one or more wireless transceivers, a request frame soliciting approval from a second device to enable DSO functionality in a link of the first device. The request frame indicates a DSO subband, a padding delay value indicating a time required by the first device to switch from a primary subband to the DSO subband, and a transition delay value indicating a time required by the first device to switch from the DSO subband to the primary subband. The one or more processors of the first device are further arranged to receive, via the one or more wireless transceivers and in response to the request frame, an approval from the second device to enable DSO functionality in the link of the first device. In response to the approval from the second device, the first device enables DSO functionality.

This third embodiment includes optional aspects. With one optional aspect, the one or more processors are further arranged to receive, via the one or more wireless transceivers, a control frame from the second device, the control frame including a request that the first device switch to the DSO subband at the beginning of a transmission opportunity (TXOP). In response, the first device switches from the primary subband to the DSO subband and performs, during the TXOP, a frame exchange with the second device via the DSO subband. In another optional aspect, the one or more processors are further arranged to switch, at or prior to the end of the TXOP, the first device from the DSO subband to the primary subband.

In yet another optional aspect, the one or more processors are further arranged to determine to change an operating bandwidth of the first device to a new operating bandwidth and, in response, disable DSO functionality in the first device. In another optional aspect, disabling DSO functionality in the first device does not include transmitting an Action frame to the second device. In yet another optional aspect, the DSO subband is not included in an operating bandwidth of the first device. In this optional aspect, the one or more processors are further arranged to set an intra-Basic Service Set (BSS) network allocation vector (NAV) timer value of the first device based on a frame received by the first device via the primary subband, and switch from the primary subband to the DSO subband while maintaining the intra-BSS NAV timer.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for Dynamic Subband Operation (DSO) between devices of a wireless network, the method comprising:
transmitting, by a first device, a request frame soliciting approval from a second device to enable DSO functionality in a link of the first device, wherein the second device supports DSO functionality in the link, and wherein the request frame indicates a requested DSO subband) and:
a padding delay value indicating a time required by the first device to switch from a primary subband to the DSO subband; and
a transition delay value indicating a time required by the first device to switch from the DSO subband to the primary subband;
receiving, in response to the request frame, an approval from the second device to enable DSO functionality in the link of the first device; and
in response to the approval from the second device, enabling DSO functionality in the link of the first device.

2. The method of claim 1, further comprising:
receiving a control frame from the second device, the control frame including a request that the first device switch to the DSO subband at the beginning of a transmission opportunity (TXOP);
switching, by the first device, from the primary subband to the DSO subband; and
performing, during the TXOP, a frame exchange with the second device via the DSO subband.

3. The method of claim 2, further comprising:
switching, at or prior to the end of the TXOP, from the DSO subband to the primary subband.

4. The method of claim 1, further comprising:
determining, by the first device, to change an operating bandwidth of the first device to a new operating bandwidth; and
disabling DSO functionality in the first device in response to determining to change the operating bandwidth.

5. The method of claim 4, wherein disabling DSO functionality in the first device does not include transmitting an Action frame to the second device.

6. The method of claim 4, wherein disabling DSO functionality in the first device includes transmitting an Action frame to the second device.

7. The method of claim 1, further comprising:
enabling, by the first device, an enhanced Multi-Link Single Radio (eMLSR) mode on the DSO subband.

8. The method of claim 7, further comprising:
announcing, by the first device, an eMLSR padding delay and eMLSR transition delay.

9. The method of claim 1, wherein the DSO subband is not included in an operating bandwidth of the first device, the method further comprising:
setting an intra-Basic Service Set (BSS) network allocation vector (NAV) timer value of the first device based on a frame received by the first device via the primary subband; and
switching, by the first device, from the primary subband to the DSO subband and maintaining the intra-BSS NAV timer.

10. The method of claim 1, further comprising:
receiving a DSO disablement announcement for the link from the second device; and
automatically disabling DSO functionality in the first device in response to the announcement from the second device.

11. The method of claim 1, wherein the first device is a non-Access Point Multi-Link Device (non-AP MLD) and the second device is an Access Point Multi-Link Device (AP MLD).

12. A method for Dynamic Subband Operation (DSO) between devices of a wireless network, the method comprising:
receiving, by a first device, a request frame soliciting approval from the first device to enable DSO functionality in a link of a second device, wherein the request frame indicates a requested DSO subband and:
a padding delay value indicating a time required by the second device to switch from a primary subband to the DSO subband; and
a transition delay value indicating a time required by the second device to switch from the DSO subband to the primary subband; and
transmitting, in response to the request frame, an approval to the second device to enable DSO functionality in the link of the second device.

13. The method of claim 12, further comprising:
transmitting, by the first device, a control frame for reception by the second device, the control frame including a request that the second device switch to the DSO subband at the beginning of a transmission opportunity (TXOP); and
performing, during the TXOP, a frame exchange with the second device via the DSO subband.

14. The method of claim 13, wherein performing a frame exchange with the second device includes:
transmitting, by the first device, a frame including a duration field set to a value that protects a subsequent exchange of frames during the TXOP.

15. The method of claim 13, wherein performing a frame exchange with the second device includes:
transmitting, by the first device, a frame configured to ensure that an end time of a last frame exchange with the second device precedes the end time of the TXOP by at least the transition delay value.

16. A first device, comprising:
one or more wireless transceivers; and
one or more processors operably coupled to the one or more wireless transceivers, wherein the one or more processors are arranged to:
transmit, via the one or more wireless transceivers, a request frame soliciting approval from a second device to enable DSO functionality in a link of the first device, wherein the request frame indicates a requested DSO subband and at least one of:
a padding delay value indicating a time required by the first device to switch from a primary subband to the DSO subband; or
a transition delay value indicating a time required by the first device to switch from the DSO subband to the primary subband;
receive, via the one or more wireless transceivers and in response to the request frame, an approval from the second device to enable DSO functionality in the link of the first device; and
in response to the approval from the second device, enable DSO functionality in the link of the first device.

17. The first device of claim 16, wherein the one or more processors are further arranged to:
receive, via the one or more wireless transceivers, a control frame from the second device, the control frame including a request that the first device switch to the DSO subband at the beginning of a transmission opportunity (TXOP);
switch from the primary subband to the DSO subband; and
perform, during the TXOP, a frame exchange with the second device via the DSO subband.

18. The first device of claim 17, wherein the one or more processors are further arranged to:
switch, at or prior to the end of the TXOP, from the DSO subband to the primary subband.

19. The first device of claim 16, wherein the one or more processors are further arranged to:
determine to change an operating bandwidth of the first device to a new operating bandwidth; and
disable DSO functionality in the first device in response to determining to change the operating bandwidth.

20. The first device of claim 19, wherein disabling DSO functionality in the first device does not include transmitting an Action frame to the second device.

21. The first device of claim 16, wherein the DSO subband is not included in an operating bandwidth of the first device, and wherein the one or more processors are further arranged to:
set an intra-Basic Service Set (BSS) network allocation vector (NAV) timer value of the first device based on a frame received by the first device via the primary subband; and
switch from the primary subband to the DSO subband while maintaining the intra-BSS NAV timer.
